(19) United States
(12) Patent Application Publication
(10) Pub. No.: US 2011/0087914 A1
(43) Pub. Date: Apr. 14, 2011

(54) I2C BUFFER CLOCK DELAY DETECTION METHOD

(75) Inventors: Jace Files, Garland, TX (US); David Marten, Sachse, TX (US)

(73) Assignee: Enfora, Inc., Richardson, TX (US)

(21) Appl. No.: 12/870,597

(22) Filed: Aug. 27, 2010

Related U.S. Application Data
(60) Provisional application No. 61/238,059, filed on Aug. 28, 2009.

(51) Int. Cl. G06F 1/04; G06F 13/00

(52) U.S. Cl. 713/600; 710/110

(57) ABSTRACT

Systems and methods are disclosed that promote communication in an I2C Bus. These systems and methods include establishing a connection between at least two units within coupled together in a I2C bus, transmitting a message from a master to a slave, transitioning the slave to below a threshold during communications, and delaying additional messages from the master to the slave.

### CROSS-REFERENCE TO RELATED APPLICATION(S) AND CLAIM OF PRIORITY

The present application is related to U.S. Provisional Patent No. 61/238,059, filed Aug. 28, 2009, entitled “I2C BUFFER CLOCK DELAY BUS BUFFER”. Provisional Patent No. 61/238,059 is assigned to the assignee of the present application and is hereby incorporated by reference into the present application as if fully set forth herein. The present application hereby claims priority under 35 U.S.C. §119(e) to U.S. Provisional Patent No. 61/238,059.

### TECHNICAL FIELD

Generally, the invention relates to data packets, and, more particularly, relates to optimizing data using delays created within the I²C protocol.

### BACKGROUND

I²C (Inter-Integrated Circuit) is a multi-master serial computer bus that may used to attach low-speed peripherals to a variety of devices. These devices may be any kind of electronic device including, but not limited to, portable electronic devices, motherboards, cellular telephones, or any other device that uses an integrated circuit. I²C is operable through two bidirectional open-drain lines. These lines are a Serial Data (SDA) and Serial Clock (SCL) which may be pulled up with resistors. Typical voltages are generally selected from the group of +5 V and +3.3 V although systems with other, higher or lower, voltages are operable using the I²C bus.

It is understood that since current implementations require the I²C bus to be pulled up with at least one resistor, the voltages for each device within the I²C bus must be the same. This limitation inhibits connections of devices that have voltages that do not match.

The I²C reference design has a 7-bit address space with 16 reserved addresses, so a maximum of 112 nodes can communicate on the same bus. Common I²C bus modes include the 400 kbit/s Fast mode (Fm), the 1 Mbit/s Fast mode plus (Fm+), the 3.4 Mbit/s High Speed mode (HSm), the 100 kbit/s standard mode and the 10 kbit/s low-speed mode. Recent revisions of I²C also support other extended features, such as 10-bit addressing.

The bit rates discussed above relate to transactions between a master and a slave without clock stretching or other hardware overhead. One of the problems with the current implementations of the I²C is the protocol overheads which include a slave address and a register address within the slave device as well as per-byte ACK/NACK bits. Therefore, the actual transfer rate of user data is lower than those peak bit rates. For example, if each interaction with a slave inefficiently allows only 1 byte of data to be transferred, the data rate will be less than half the peak bit rate.

The maximum number of nodes is also limited by the total bus capacitance of 400 pF. This both restricts practical communication distances to a few meters, and limits the number of devices that may be connected simultaneously. Because of this, the usage of the I²C bus is inherently limited to only a few devices located in immediate proximity may communicate.

Accordingly, there are needed systems and methods that extend and optimize the I²C bus.

### SUMMARY

In one embodiment, a method is disclosed that includes establishing a connection between at least two units coupled together on an I2C bus, transmitting a message from a master to a slave, transitioning the slave clock to below a threshold during communications, and preventing additional messages from being transmitted from the master to the slave.

In another embodiment, a communications system is disclosed that includes at least two I2C communication units; and a connector that creates a connection between at least two I2C communication units and maintains a low clock signal between the clocks of the at least two I2C communication units during communication.

### BRIEF DESCRIPTION OF THE DRAWINGS

The I²C bus allows a plurality of devices to be connected. However, the I²C bus has a number of limitations that limit its flexibility. These limitations include a structure that requires matching voltage of all connected devices, limitations on bus length and capacitance, and a significant amount of overhead inherent in the I²C bus scheme. In order to overcome these limitations, the present systems and methods are disclosed which overcome these problems with the I²C bus.

FIG. 1 is an overview of a plurality of devices that are connected using the I²C bus. Unit A 102 and Unit B 104 are connected to an enhanced I²C connector (EIC) 106 using a SCL (Serial Clock Line) and SDA (Serial Data Line). Unit C 110 and Unit D 112 are also connected to the EIC 106 through a SLC-2 and a SDA-2 signal line. It is understood that the I²C bus physically consists of the two active wires (SCL and SDA) and a ground connection (not shown). The active wires are both bi-directional.

Unit A 102 and Unit B 104 are within group 108, and Unit C 110 and Unit D 112 are within group 114. Each group 108, 114 share the same voltage rating, but group 108 and group 114 may not share the same voltage rating. Using EIC 106, Unit A 102 may communicate with Unit D 112, even though Unit A 102 and Unit D 112 may not communicate with the same voltage. Moreover, EIC 106 may, in some embodiments, be used as a hub to overcome the capacitance limitation discussed above, thereby allowing devices to communicate over longer distances. In addition, the EIC 106 may promote more efficient communications by interpreting signals thereby allow signals to be held during certain operations thereby reducing communications overhead. These, and other embodiments, will be discussed in more detail below.

Every device hooked up to the disclosed I²C bus has its own unique address, no matter whether it is an MCU, LCD driver, memory, or ASIC. Each of these chips can act as a receiver and/or transmitter, depending on the functionality.

Unit A 102, Unit B 104, Unit C 110, and Unit D 112 may be any device with an integrated circuit. Examples include, but are not limited to, sensors, input devices, output devices, storage interfaces, MCU, LCD driver, memory, ASIC, or any other device with an integrated circuit or the ability to communicate over the I²C bus.

EIC 106 comprises sensors 126, processor 11E, an I2C Buffer State Machine 200, power source 130, first port 140, second port 142, and memory 120. Memory 120 comprises settings 118. It is understood that some of these components may not be used in every embodiment of EIC 106. It is understood that EIC 106 may be implemented as a programmable gate array or any kind of programmable logic. The state machine 200 which may be executed by processor 116 is discussed in FIG. 2.

Group 108 connects to EIC 106 through second port 142 and group 114 connects to EIC 106 through first port 140. It is understood that the first port 140 and second port 142 are connections along an I2C bus that allow group 108 and group 114 to connect to EIC 106.

Sensors 126 may be used to detect the appropriate voltage for Unit A 102, Unit B 104, Unit C 110, and Unit D 112. It is understood that the sensors 126 may be used to operably and dynamically modify bus behavior in order to facilitate connectivity between group 108 and group 114, by modifying bus voltage levels. For instance if one group is rated at 3v and another group is rated at 5.5v, the sensors may be used to detect the voltage in a group and adjust the voltage of signals going to that group. In this example, the group that is rated at 3v will only receive signals of 3v, the groups that are at 5.5v will only receive signals at 5.5v.

It is understood that the sensors may not be used in every embodiment. For instance, in some embodiments, the groups will be assigned to a port on EIC 106 that corresponds to the correct voltage.

Processor 116 may be used to promote communications with groups 108 and 114. It is understood that the processor 116 may interpret signals from Unit A 102, Unit B 104, Unit C 110, and Unit D 112 and alter these signals to further allow for communications.

Power source 130 may be used to provide additional power in the event that group 108 and group 114 are of differing voltage requirements. Power source 130 may be used to regulate signals thereby allowing each group to communicate with every other group using the native power settings of the group.

Memory 120 may comprise settings 118 used by the processor or the state machine to control how instructions may be interpreted by the state machine and processor as will be described in more detail in FIGS. 2 and 4.

The I²C bus is a multi-master bus. More than one unit capable of initiating a data transfer can be connected to the bus. The I²C protocol specification states that the unit initiating a data transfer on the bus is considered the Bus Master. Consequently, at that time, all the other units are regarded to be Bus Slaves.

For example, if Unit A 102 wants to send data to Unit B 104, Unit A, acting as the master, will issue a START condition. This acts as an ‘Attention’ signal to all of the connected devices. All units on the bus will listen to the bus for incoming data.

Then Unit A 102 sends the ADDRESS of the device it wants to access (Unit B), along with an indication whether the access is a Read or Write operation. For the purpose of this example, it will be a write operation. Having received the address, all units on the bus will compare it with their own address. If it doesn't match, they simply wait until the bus is released by the stop condition. If the address matches, however, the Unit, in this example UNIT B, will produce a response called the ACKNOWLEDGE signal.

Once Unit A receives an acknowledgement signal, it can start transmitting or receiving DATA. In our case, the Unit A will transmit data. When all is done, Unit A will issue the STOP condition. This is a signal that the bus has been released and that the connected Units may expect another transmission to start any moment, or the other units may initiate a data transmission.

There are several states on the bus used in the forgoing example: START, ADDRESS, ACKNOWLEDGE, DATA, STOP. These are all unique conditions on the bus. EIC 106 leverages these commands by providing a number of novel and unique applications to the I²C bus. The innovative systems and methods using the I²C will be discussed more fully below.

In one embodiment of the present disclosure, when the EIC 106 is implemented in a custom asic or programmable logic device (“implementation device”), the EIC 106 can electrically isolate two separate sides of the same I²C bus allowing the capacitive load restrictions of the I²C protocol to be bypassed, and allowing devices operating and communicating at different voltages to be connected on the same I²C bus. This isolation may be made between separate groups, where each group may (or may not) have the same voltage requirements.

The EIC 106 intelligently analyzes and processes the I²C traffic and uses the information being sent/received to know what to do and how to do it. Additionally, the implementation device operates in a multi-master mode so that either side of the implementation device can initiate I²C traffic to any device connected on the I²C bus.

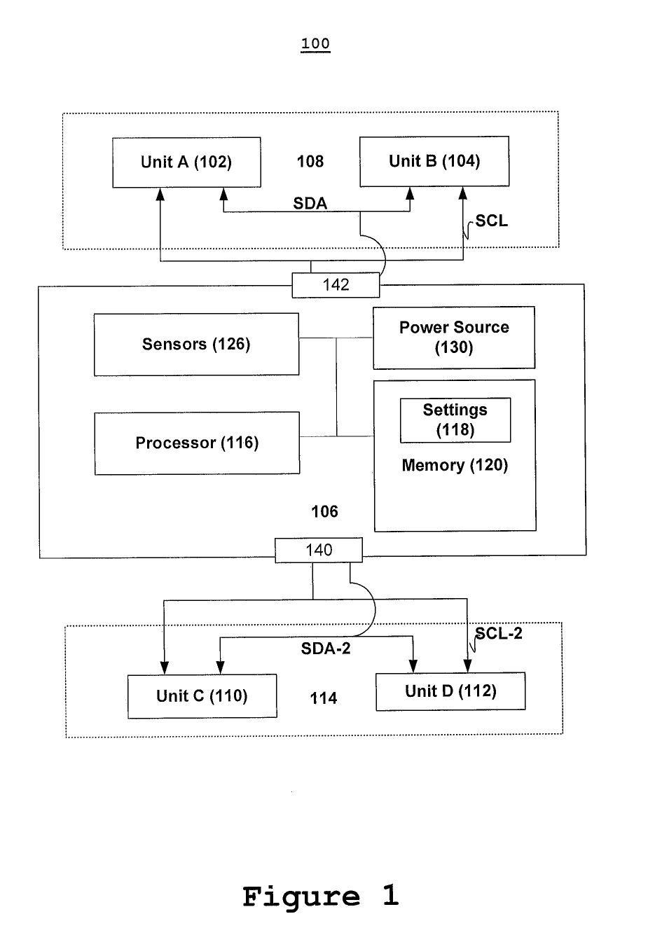

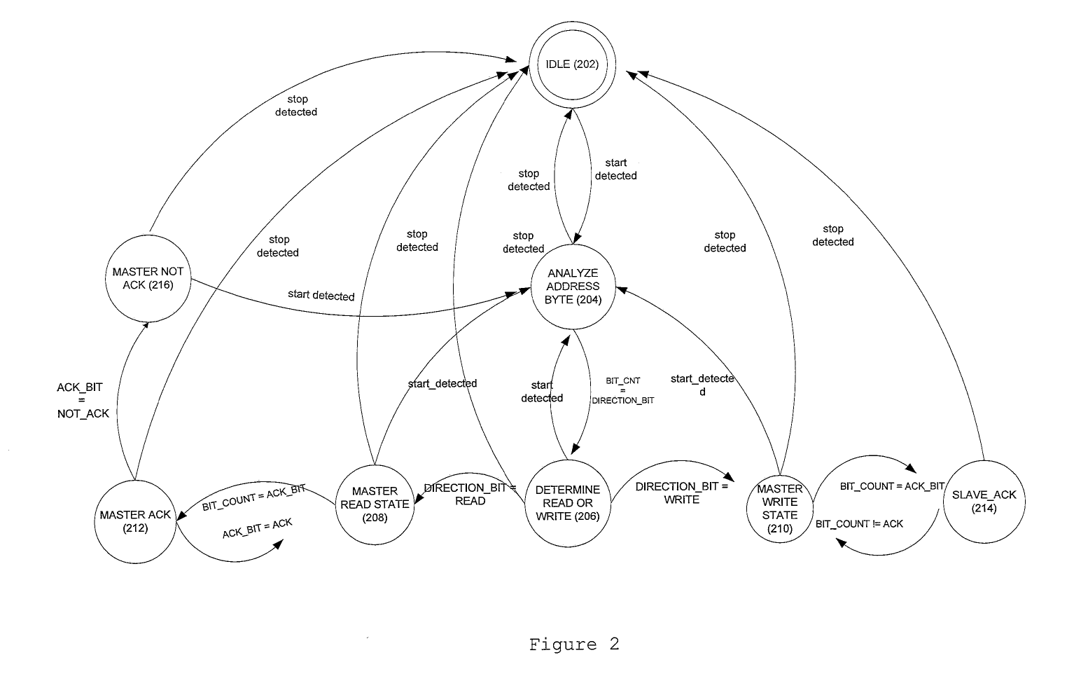

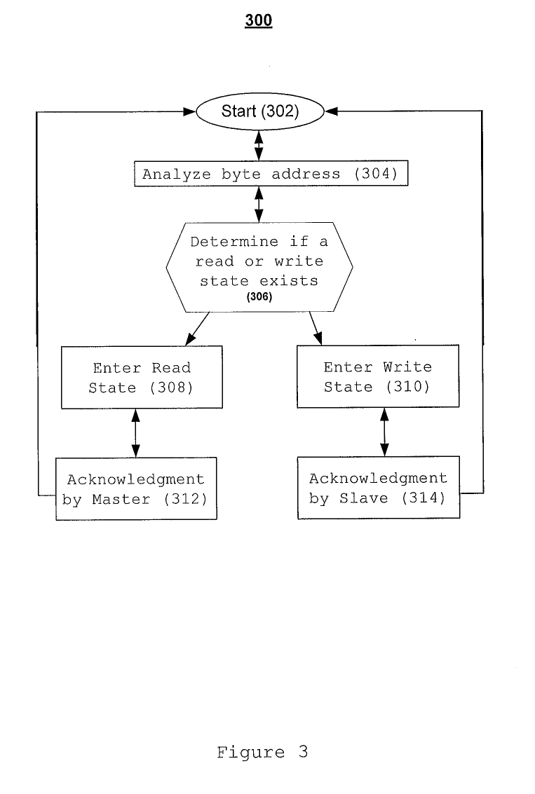

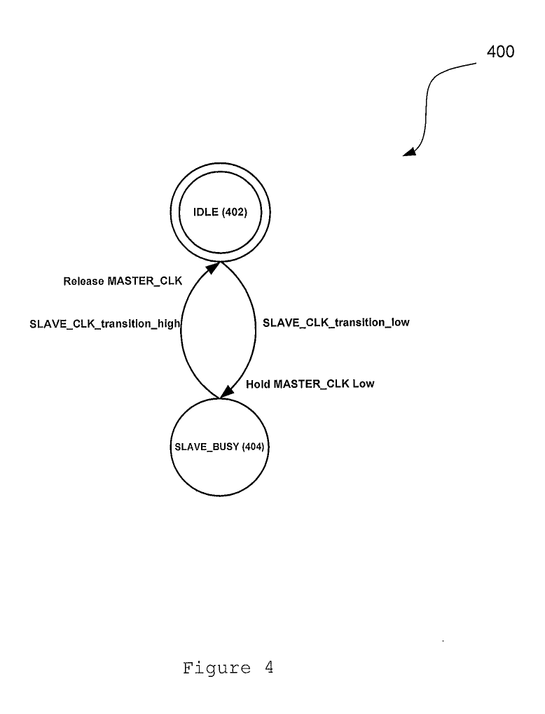

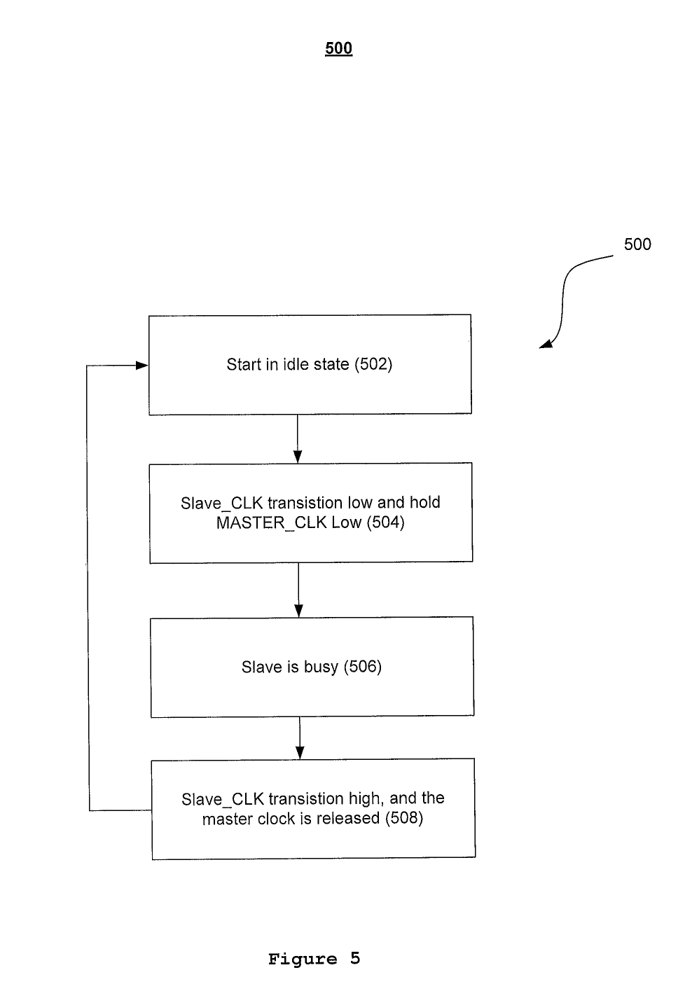

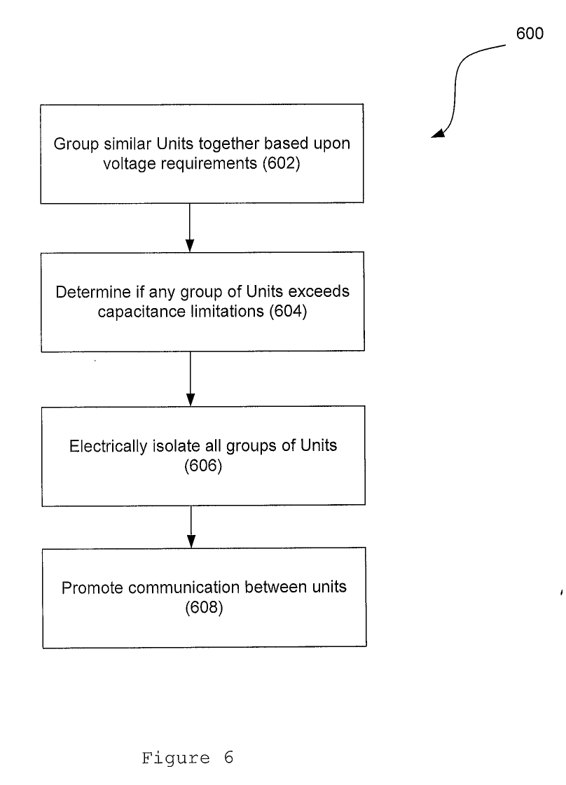

In FIG. 2, an I²C buffer state diagram is shown that may be used in the EIC 106. The state diagram is useful when there are a plurality of groups, such as groups 108 and 114. It is understood that the I²C bus is monitored, including the monitoring of groups 108 and 114, to watch for a “START” condition. When the “START” condition is detected, the group sending the “START” (now labeled as GROUP MASTER) is allowed to pass through data to the other groups (now labeled the GROUP SLAVE) while the state machine controls all acknowledgements and no-acknowledgements so that they are allowed to pass through from the SLAVE side to the MASTER side. The algorithm used to control the state machine of the buffer device is unique in the way it is implemented and how it counts and controls the data that is being passed through. The MASTER and SLAVE sides are mapped and passed through to each other through this state machine. While a single group master and slave are illustrated in FIG. 1, it is explicitly understood that a plurality of groups may be present with a plurality of groups. In such a configuration any number of different units may be present with any number of different groups with any number of voltages.

In this diagram, the state machine may start with an idle state 202. If there is a start detected on one I2C bus (e.g. SDA-1/SCL-1), the state machine analyzes at least one by address to determine the type of operation in state 204. In this example, the master bus is SDA-1. While in state 204, the state machine passes all data to the second I2C bus (e.g. SDA-2/SCL-2), and analyzes the data to determine whether it is a read or write operation. If the direction byte in state 206 indicates that it is a read byte, the state machine enters state 208. After the state machine registers a master read state 208, the second I2C bus will be monitored for data in state 212. If data is detected, it will be passed to the first I2C bus, the second I2C bus will be declared the slave I2C bus, and any acknowledgements from the first I2C bus will be passed to the second I2C bus. If a stop is detected during this process, the state machine will return to Idle. It is understood if there is no acknowledgement, then the state machine will switch to state 216 indicating that the master has not been acknowledged. This implementation will allow transfer of data and acknowledgement between the two I2C busses for read transactions without requiring that the state machine be aware of the addresses on either of the I2C busses.

If the direction byte in state 206 indicates that it is a write byte, the state machine enters state 210. The state machine then monitors the second I2C bus for an acknowledgement from a slave in state 214. If the acknowledgement is detected in state 214, it will be passed to the first I2C bus. As indicated in FIG. 2, most states may return to an idle state 202 upon completion of an operation or to analyze address byte state 204 upon the initiation of a new operation.

FIG. 3 is a flowchart 300 of one method of using the state machine illustrated in FIG. 2. In block 302, the method starts. The method may start with an idle state of the state machine. In block 304, the byte address of a block is an analyzed to determine if it is a read function or a write function.

If in block 306 it is determined that there is a write operation, there is a write state that is entered in block 310. This write state is acknowledged by the slave in block 314. After the write operation is completed, the state machine returns to the start position indicated in block 302.

If in block 306 it is determined that a read operation is occurring, then a read state is entered in block 308. This read state is acknowledged by the master in block 312. After the read operation is completed, the state machine returns to the start position indicated in block 302.

In FIG. 4 a second state machine 400 is shown that illustrates a method of detecting the delay clock in the I²C buffer in environments where a half-duplex I²C buffer is used or where a I²C voltage translation is used, such as the one used by EIC 106. It is understood that the I²C protocol allows for a slave device to hold the clock low if the slave is not ready for additional data. This creates a problem in the I²C buffer since their was no way for the Master side of the clock line to detect when the slave side of the clock line was held low due to the nature of the half-duplex buffer. In one embodiment, this problem is overcome by allowing the I²C buffer to hold the clock line low on the Master side until it senses that the slave side clock has risen above the VIH threshold. At this point it will allow the Master side clock line to rise thus continuing the I²C transaction. If the slave needs to hold the clock low because it is busy, then the Master clock will already be held low until the slave side is eventually ready to continue the transaction.

In FIG. 4, the idle state 402 is shown transiting into the state where the slave is busy (SLAVE_BUSY 404) through a slave clock transition low signal where the master clock is held low. When the state of the slave changes to being idle the slave clock transitions high and the master clock is released indicating that the slave has returned to idle state 402 and is ready to receive additional data.

FIG. 5 is a flowchart illustrating the use of the state machine disclosed in FIG. 4. In this flowchart, the system starts in an idle state as shown by block 502. The Slave clock is transitioned low and the master clock is held low in block 504. In block 506, the slave is busy. In block 508, the slave clock is transitioned high and the master clock is released.

FIG. 6 is a flowchart illustrating one method of using EIC 106. In block 602, groups of similar units are grouped together based upon voltage requirements. In block 604, there is a determination if any group of units exceeds capacitance limitations. For instance, if there are too many units within a particular group, that group may be broken up into smaller groups that do not exceed capacitance limits. In block 606, each group of units is electrically isolated using EIC 106. In block 608, communication is promoted using EIC 106.

As illustrated above, the I²C interface is an open-drain multi-master bus interface. Therefore, the number of devices that can be connected to the bus is limited by line capacitance. As more devices are connected to the I²C bus line, the capacitance of the I²C bus increases. The rise time of the line increases because the pull-up resistors must charge a larger capacitance for the voltage to rise for a digital “1”. Using the disclosed systems and methods, including the method described by FIG. 6, the implementation device can extend the number of devices connected to the I²C bus since each end of the implementation device terminates the line capacitance. This allows the number of devices on the I²C bus to be continuously extended as needed without being limited by capacitive load.

Additionally, the multi-master implementation of these systems and methods allows either side of the implementation device to initiate transfers with no loss of data or additional protocols.

Furthermore, because the implementation device electrically isolates two separate parts of the same I²C bus, these systems and methods will allow devices that operate and communicate at different voltages to be connected to the same I²C bus.

It is understood that the presently disclosed systems and methods may be logically be extended to bridging 3 or more I2C busses.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

We claim:

1. A method, comprising:
establishing a connection between at least two units within coupled together in a I2C bus, wherein each of the at least two units is a I2C communication unit, and wherein one of the at least two units is a master and one of the at least two units is a slave;
transmitting a message from the master to the slave;
transitioning the slave clock to below a threshold during communications; and
preventing additional messages from being transmitted from the master to the slave.

2. The method of claim 1, wherein the slave maintains a threshold voltage that prevents additional messages from being transmitted from the master to the slave.

3. The method of claim 1, wherein upon transition of the slave clock signal to high the master begins to transmit additional messages to the slave.

4. A communications system, comprising:
a master unit, wherein the master comprises a master clock signal generator that creates a master clock signal;
a slave unit, wherein the slave comprises a slave clock signal generator that creates a slave clock signal, wherein the slave clock signal transitions from a high state to a low state during communications, and wherein the slave clock signal transitions from a low state to a high state upon completion of communications.

5. The system of claim 4, wherein the master clock signal transitions from a high state to a low state during communications.

6. The system of claim 5, wherein the master clock signal transitions from a low state to a high state upon completion of communications.

7. The system of claim 6, wherein the master unit refrains from further communication while the master clock is in a low state.

8. The system of claim 7, wherein the master clock is held in a low state by the slave unit.

9. A communications system, comprising:
at least two I2C communication units; and
a connector, wherein the connector creates a connection between at least two I2C communication units, wherein the connector maintains a low clock signal between the clocks of the at least two I2C communication units during communication.

10. The system of claim 9, wherein at least one of the at least two I2C communication units is a master unit and at least one of the at least two I2C communication units is a slave unit.

11. The system of claim 10, wherein the slave unit transmits a release signal to the connector indicating that the slave unit is prepared to receive additional information.

12. The system of claim 11, wherein the release signal is a clock signal of the slave unit.

13. The system of claim 12, wherein upon receiving the release signal the connector transitions the master clock to a high state.

14. The system of claim 13, wherein upon the master clock being transition to a high state the master unit sends additional information.

15. The system of claim 13, wherein upon the master clock being transition to a high state the master unit becomes idle.

16. The system of claim 13, wherein upon the master clock becoming idle, a second unit becomes a second master unit and initiates data traffic by transitioning the second master unit clock to high.

17. A system, comprising:
at least two groups, wherein each of the two groups comprise at least one I2C communication units, and wherein each of the I2C communication units within a group are coupled together; and
a connector, wherein the connector creates a connection between at least two groups of units, wherein the connector maintains a low clock signal between the clocks of the at least two I2C communication units during communication.

18. The system of claim 17, wherein at least one of the at least two I2C communication units is a master unit and at least one of the at least two I2C communication units is a slave unit.

19. The system of claim 18, wherein the slave unit transmits a release signal to the connector indicating that the slave unit is prepared to receive additional information.

20. The system of claim 17, wherein the release signal is a clock signal of the slave unit.

21. The system of claim 20, wherein upon receiving the release signal the connector transitions the master clock to a high state.
